(19) United States
(12) Patent Application Publication
(10) Pub. No.: US 2016/0234242 A1
(43) Pub. Date: Aug. 11, 2016

(54) APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS

(71) Applicant: Honeywell International Inc., Morris Plains, NJ (US)

(72) Inventors: Eric D. Knapp, Milton, NH (US); Seth G. Carpenter, Phoenix, AZ (US); Andrew W. Kowalczyk, Phoenix, AZ (US)

(21) Appl. No.: 14/871,814

(22) Filed: Sep. 30, 2015

Related U.S. Application Data
(60) Provisional application No. 62/114,865, filed on Feb. 11, 2015.

(51) Int. Cl. H04L 29/06

(52) U.S. Cl. CPC H04L 63/1433

(57) ABSTRACT

This disclosure provides an apparatus and method for providing possible causes, recommended actions, and potential impacts related to identified cyber-security risk items. A method includes identifying, by a risk manager system, a plurality of connected devices that are vulnerable to cyber-security risks. The method includes identifying, by the risk manager system, cyber-security risks in the connected devices. The method includes, for each identified cyber-security risk, identifying by the risk manager system at least one possible cause, at least one recommended action, and at least one potential impact. The method includes displaying, by the risk manager system, a user interface that includes a summary of the identified cyber-security risks.

### CROSS-REFERENCE TO RELATED APPLICATION

This application claims the benefit of the filing date of U.S. Provisional Patent Application 62/114,865, filed Feb. 11, 2015, which is hereby incorporated by reference.

### TECHNICAL FIELD

This disclosure relates generally to network security. More specifically, this disclosure relates to an apparatus and method for providing possible causes, recommended actions, and potential impacts related to identified cyber-security risk items.

### BACKGROUND

Processing facilities are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern, and unaddressed security vulnerabilities in any of these components could be exploited by attackers to disrupt operations or cause unsafe conditions in an industrial facility.

### SUMMARY

This disclosure provides an apparatus and method for providing possible causes, recommended actions, and potential impacts related to identified cyber-security risk items. A method includes identifying, by a risk manager system, a plurality of connected devices that are vulnerable to cyber-security risks. The method includes identifying, by the risk manager system, cyber-security risks in the connected devices. The method includes, for each identified cyber-security risk, identifying by the risk manager system at least one possible cause, at least one recommended action, and at least one potential impact. The method includes displaying, by the risk manager system, a user interface that includes a summary of the identified cyber-security risks.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIGS. 2A through 2C illustrate an example graphical user interface for providing possible causes, recommended actions, and potential impacts related to identified cyber-security risk items according to this disclosure; and

FIG. 3 illustrates a flowchart of a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

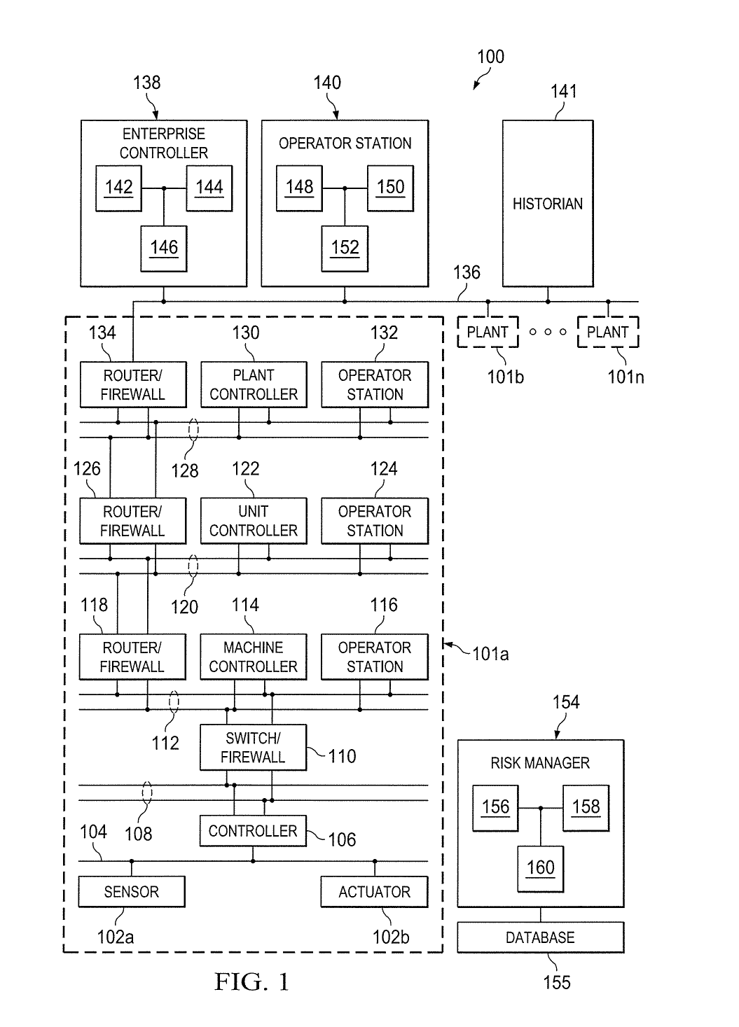

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

As noted above, cyber-security is of increasing concern with respect to industrial process control and automation systems. Unaddressed security vulnerabilities in any of the components in the system 100 could be exploited by attackers to disrupt operations or cause unsafe conditions in an industrial facility. However, in many instances, operators do not have a complete understanding or inventory of all equipment running at a particular industrial site. As a result, it is often difficult to quickly determine potential sources of risk to a control and automation system. This disclosure recognizes a need for a solution that understands potential vulnerabilities in various systems, prioritizes the vulnerabilities based on risk to an overall system, and guides a user to mitigate the vulnerabilities.

Moreover, in the context of an industrial process control and automation system, personnel within industrial control environments (such as industrial plants) are not typically trained to deal with cyber-security threats, vulnerabilities, and risks. Because of this, cyber-security tools often provide less value in those contexts because users are unlikely to fully understand what the information being presented means to them and their facilities. Disclosed embodiments address this issue by providing information and advice to a user, educating the user during use. For example, if an indicator of a cyber-security risk is presented, the indicator can be explained in layman's terms. Also, possible causes of the indicator can be explained, as well as potential impacts to an industrial facility. Advice on what actions should be taken to resolve a specific cause of a risk can further be provided to help guide the user to take appropriate steps towards risk mitigation.

This can be accomplished (among other ways) using a risk manager 154. Among other things, the risk manager 154 supports a technique for providing possible causes, recommended actions, and potential impacts related to identified cyber-security risk items. As a particular example of this functionality, when the risk manager 154 identifies an indicator of a cyber-security risk (such as by using a rule engine), the risk manager 154 uses that indicator to determine possible causes, recommended actions, and potential impacts associated with the risk. Values for these three items can be determined using the indicator, such as by retrieving associated information from a database 155. When a rule triggers and identifies a risk item, the relevant values can be retrieved from the database 155, associated with the indicator, and displayed within a user interface (such as under an “additional details” option in the user interface). The three values may be statically defined, reference other areas of the risk manager 154, and/or make calls for additional information.

The “possible causes” values are typically influenced by the risk indicator itself and involve a database lookup to determine the values. For cyber-security vulnerabilities, causes can often include misconfigurations or inherent weaknesses in software. For cyber-security threats, causes can often include actual hacking of a device or exposure of a device to malware.

The “potential impacts” values are often determined for a risk indicator based on the target or targets to which a risk applies (such as a PC or other networked device, a “zone” containing multiple devices, etc.). The risk indicator can be cross-referenced against outside criteria, such as the possible impact of the specific risk item or the potential impact due to the loss of a target device or other devices that are dependent on the target device (such as process controllers, I/O devices, etc.). In various embodiments, the risk manager 154 can uses its understanding of the network architecture, such as industrial process control and automation system 100, and specific connected control devices to identify what control assets could be impacted by a cyber incident targeting a device at higher levels in the Purdue model.

The “recommended actions” values are typically influenced by the risk indicator itself and can be determined by cross-referencing specific risk items to the database 155 of relevant actions or mitigations.

In this example, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions. The database 155 denotes any suitable structure facilitating storage and retrieval of information.

Although FIG. 1 illustrates one example of an industrial process control and automation system 100, various changes may be made to FIG. 1. For example, a control and automation system could include any number of sensors, actuators, controllers, servers, operator stations, networks, risk managers, and other components. Also, the makeup and arrangement of the system 100 in FIG. 1 is for illustration only.

Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which the functions of the risk manager 154 can be used. This functionality can be used in any other suitable device or system.

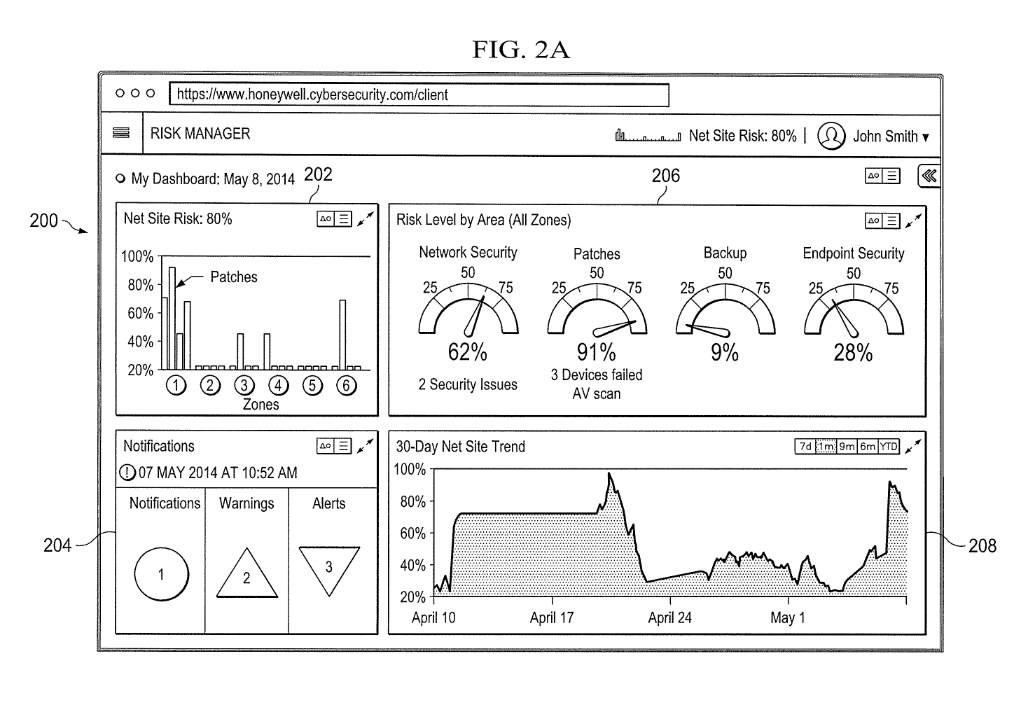

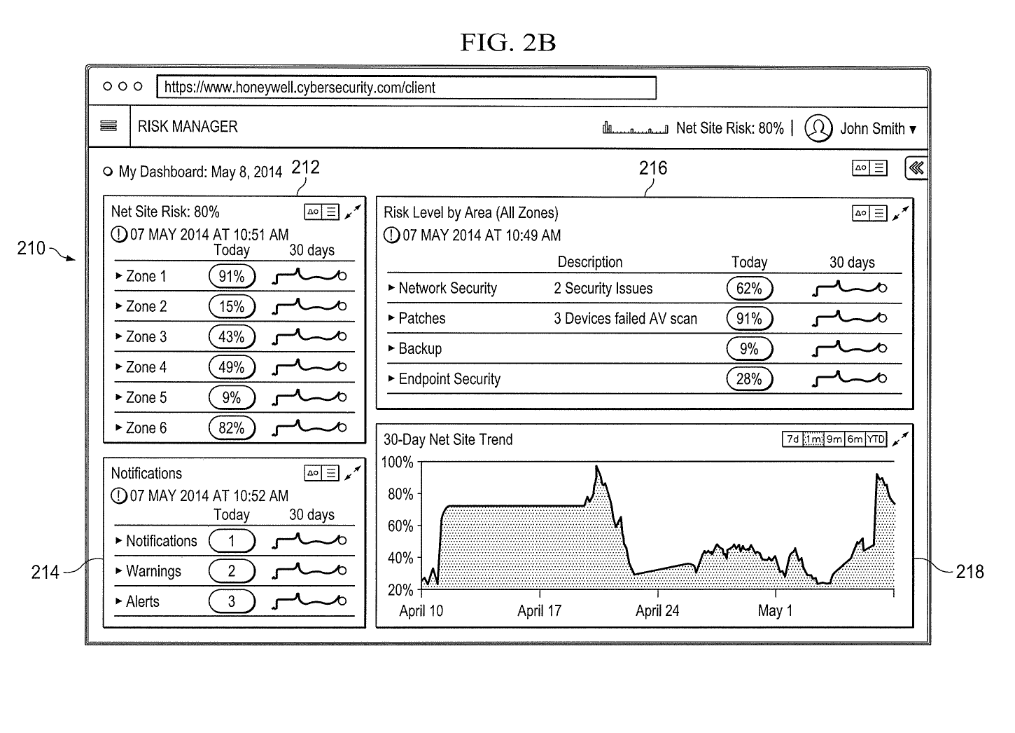

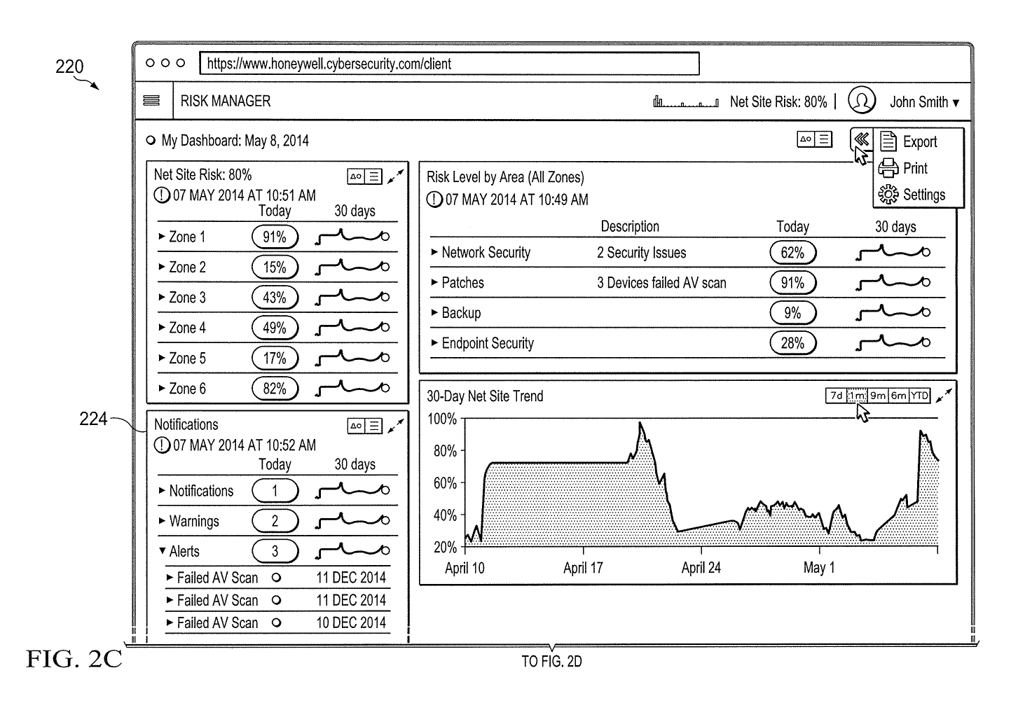

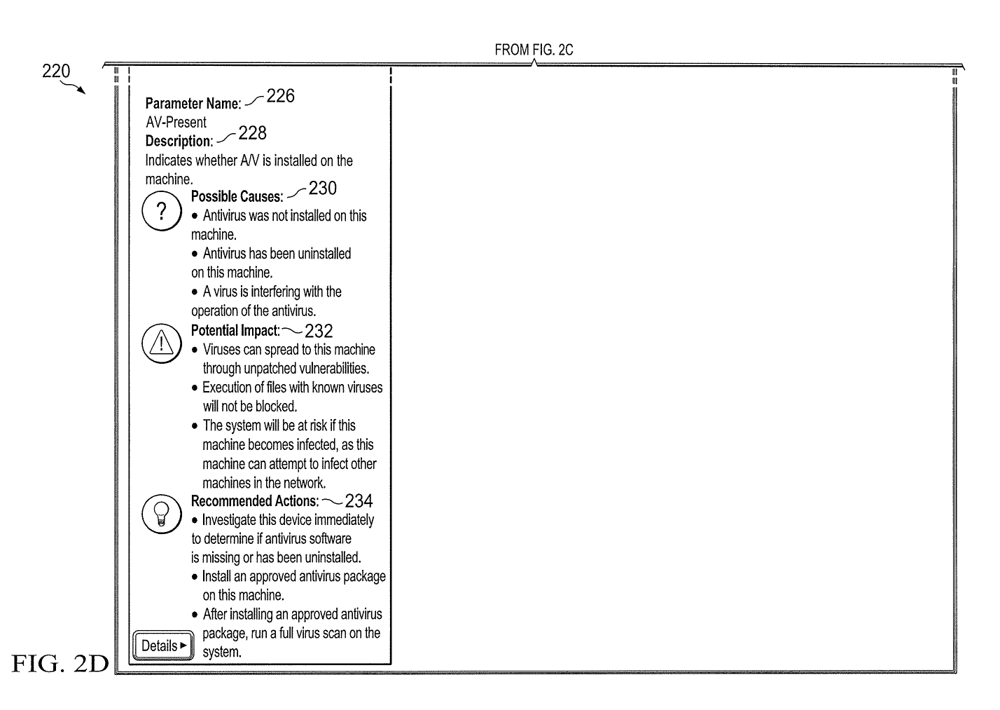

FIGS. 2A through 2C illustrate an example graphical user interface (GUI) for providing possible causes, recommended actions, and potential impacts related to identified cyber-security risk items according to this disclosure. This GUI can be implemented, for example as a display of risk manager 154 for interactions with a user, as described in more detail below. Note that, while the figures for this patent document are shown in black-and-white, the GUI can and generally will display the data using color coding to indicate such factors as relative risk level, different components or zones, or other data.

In particular, FIG. 2A illustrates a user interface 200 providing a graphical summary of the cyber-security risk items identified by the risk manager 154. User interface 200 can include a number of features to indicate cyber-security risk items and related data. User interface 200 can include a net site risk area 202 that illustrates the relative risk percentages for a plurality of system zones and risk types. As illustrated in this example, the “patches” risk type (for software that has not been fully updated or patched) is very high in system zone 1. Net site risk area 202 can also display an overall net site risk, which is shown as 80% in this example.

User interface 200 can include a notification area 204 that notifies users of important information such as notifications, warnings, and alerts. Each of these notification types can indicate a different severity, such as an alert being more severe than a warning, which is more severe than a notification. Each notification type can be represented by a different symbol or color, as illustrated. A user can select one of the symbols to see the actual notification, warning, or alert in the user interface 200.

User interface 200 can include a risk level summary 206 by area for one or more zones. In this example, risk level summary 206 uses “gauge” graphics to illustrate the risk level in each of the areas of network security, patches, backup, and endpoint security. As illustrated here, additional data can be included that describes the reason for a particular area's risk level. For example, the “network security” area shows a 62% risk level, and indicates that there are two security issues.

User interface 200 can also include a trend-view chart 208 that illustrates the net site risk over a selectable period of time. In this example, the “30-day” chart has been selected, and the trend-view chart 208 shows a 30-day net site trend.

FIG. 2B illustrates a user interface 210 providing a graphical summary of the cyber-security risk items identified by the risk manager 154, such as a list summary of the cyber-security risk items identified by the risk manager 154. User interface 210 can include a number of features to indicate cyber-security risk items and related data. User interface 200 can include a net site risk area 212 that displays, for each of a plurality of system zones, a current risk value and a 30-day risk value graph. Net site risk area 212 can also can also display an overall net site risk that indicates the relative overall cyber-security risk of the system, which is shown as 80% in this example.

User interface 210 can include a notification area 214 that notifies users of important information such as notifications, warnings, and alerts. Each of these notification types can indicate a different severity, such as an alert being more severe than a warning, which is more severe than a notification. Each notification type can be represented by a different symbol or color, as illustrated. A user can select one of the symbols to see the actual notification, warning, or alert in the user interface 200. Notification area 214 can display a 30-day notification graph for each notification type; as shown in this example, there are 30-day notification graphs for the notifications, warnings, and alerts.

User interface 210 can include a risk level summary 216 by area for one or more zones. In this example, risk level summary 216 uses a percentage number to illustrate the risk level in each of the areas of network security, patches, backup, and endpoint security. As illustrated here, additional data can be included that describes the reason for a particular area's risk level. For example, the “network security” area shows a 62% risk level, and indicates that there are two security issues. This example of the risk level summary 215 by area also includes a 30-day level chart graph for each area.

User interface 210 can also include a trend-view chart 218 that illustrates the net site risk over a selectable period of time. In this example, the “30-day” chart has been selected, and the trend-view chart 208 shows a 30-day net site trend.

FIG. 2C illustrates that a particular risk item has been selected to reveal the possible causes, potential impacts, and recommended actions for that risk item. FIG. 2C illustrates a user interface 220 that includes a notification area 224 that notifies users of important information such as notifications, warnings, and alerts. Each of these notification types can indicate a different severity, such as an alert being more severe than a warning, which is more severe than a notification. Each notification type can be represented by a different symbol or color, as illustrated. A user can select one of the symbols to see the actual notification, warning, or alert in the user interface 200. Notification area 214 can display a 30-day notification graph for each notification type; as shown in this example, there are 30-day notification graphs for the notifications, warnings, and alerts.

As illustrated in FIG. 2C, the notification area 224 can receive a user selection of a notification, warning, or alert, and in response, display details of the particular notification, warning, or alert. The details can include such details as a parameter name 226 and a description 228. The details can include possible causes 230, potential impacts 232, and recommended actions 234.

Although FIGS. 2A through 2C illustrate one example of a graphical user interface for providing possible causes, recommended actions, and potential impacts related to identified cyber-security risk items, various changes may be made to FIGS. 2A through 2C. For example, the content and layout of information in each figure is for illustration only.

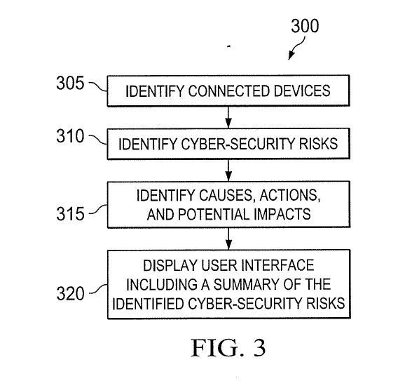

FIG. 3 illustrates a flowchart of a method 300 in accordance with disclosed embodiments, as can be performed, for example, by risk manager 154 or another device or controller (referred to as the “system” below).

The system identifies a plurality of connected devices that are vulnerable to cyber-security risks (305). These could be any of the devices or components as illustrated in FIG. 1, or others. The devices can each be associated with a zone of a system such as system 100.

The system identifies cyber-security risks in the connected devices (310). Each cyber-security risk can be classified by type such as a notification, a warning, or an alert.

For each identified cyber-security risk, the system identifies at least one possible cause, at least one recommended action, and at least one potential impact (315).

The system stores these and displays, to a user, a user interface that includes a summary of the identified cyber-security risk items identified by the risk manager (320). The summary can include graphical indicators such as trend-view charts and other charts, gauge graphics, colors or symbols to designate risk types, etc. The summary can include, for each identified cyber-security risk, the corresponding identified possible cause, recommended action, and potential impact. The summary can group the identified cyber-security risks by associated zones.

Note that the risk manager 154 and/or the graphical user interfaces shown here could use or operate in conjunction with any combination or all of various features described in the following previously-filed and concurrently-filed patent applications (all of which are hereby incorporated by reference):
U.S. patent application Ser. No. 14/482,888 entitled “DYNAMIC QUANTIFICATION OF CYBER-SECURITY RISKS IN A CONTROL SYSTEM”;
U.S. Provisional Patent Application No. 62/036,920 entitled “ANALYZING CYBER-SECURITY RISKS IN AN INDUSTRIAL CONTROL ENVIRONMENT”;
U.S. Provisional Patent Application No. 62/113,075 entitled “RULES ENGINE FOR CONVERTING SYSTEM-RELATED CHARACTERISTICS AND EVENTS INTO CYBER-SECURITY RISK ASSESSMENT VALUES” and corresponding non-provisional U.S. patent application Ser. No. ______ of like title (Docket No. H0048932-0115) filed concurrently herewith;
U.S. Provisional Patent Application No. 62/113,221 entitled “NOTIFICATION to SUBSYSTEM FOR GENERATING CONSOLIDATED, FILTERED, AND RELEVANT SECURITY RISK-BASED NOTIFICATIONS” and corresponding non-provisional U.S. patent application Ser. No. ______ of like title (Docket No. H0048937-0115) filed concurrently herewith;
U.S. Provisional Patent Application No. 62/113,100 entitled “TECHNIQUE FOR USING INFRASTRUCTURE MONITORING SOFTWARE TO COLLECT CYBER-SECURITY RISK DATA” and corresponding non-provisional U.S. patent application Ser. No. ______ of like title (Docket No. H0048943-0115) filed concurrently herewith;
U.S. Provisional Patent Application No. 62/113,186 entitled “INFRASTRUCTURE MONITORING TOOL FOR COLLECTING INDUSTRIAL PROCESS CONTROL AND AUTOMATION SYSTEM RISK DATA” and corresponding non-provisional U.S. patent application Ser. No. ______ of like title (Docket No. H0048945-0115) filed concurrently herewith;
U.S. Provisional Patent Application No. 62/113,165 entitled “PATCH MONITORING AND ANALYSIS” and corresponding non-provisional U.S. patent application Ser. No. ______ of like title (Docket No. H0048973-0115) filed concurrently herewith;
U.S. Provisional Patent Application No. 62/113,152 entitled “APPARATUS AND METHOD FOR AUTOMATIC HANDLING OF CYBER-SECURITY RISK EVENTS” and corresponding non-provisional U.S. patent application Ser. No. ______ of like title (Docket No. H0049067-0115) filed concurrently herewith;
U.S. Provisional Patent Application No. 62/114,928 entitled “APPARATUS AND METHOD FOR DYNAMIC CUSTOMIZATION OF CYBER-SECURITY RISK ITEM RULES” and corresponding non-provisional U.S. patent application Ser. No. ______ of like title (Docket No. H0049099-0115) filed concurrently herewith;
U.S. Provisional Patent Application No. 62/114,937 entitled “APPARATUS AND METHOD FOR TYING CYBER-SECURITY RISK ANALYSIS TO COMMON RISK METHODOLOGIES AND RISK LEVELS” and corresponding non-provisional U.S. patent application Ser. No. ______ of like title (Docket No. H0049104-0115) filed concurrently herewith; and
U.S. Provisional Patent Application No. 62/116,245 entitled “RISK MANAGEMENT IN AN AIR-GAPPED ENVIRONMENT” and corresponding non-provisional U.S. patent application Ser. No. ______ of like title (Docket No. H0049081-0115) filed concurrently herewith.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying, by a risk manager system, a plurality of connected devices that are vulnerable to cyber-security risks;
identifying, by the risk manager system, cyber-security risks in the connected devices;
for each identified cyber-security risk, identifying by the risk manager system at least one possible cause, at least one recommended action, and at least one potential impact; and
displaying, by the risk manager system, a user interface that includes a summary of the identified cyber-security risks.

2. The method of claim 1, wherein the summary includes graphical indicators including at least one of a trend-view chart, a 30-day graph, gauge graphics, colors, or symbols that designate risk types.

3. The method of claim 1, wherein the summary includes, for each identified cyber-security risk, the corresponding identified possible cause, recommended action, and potential impact.

4. The method of claim 1, wherein each of the connected devices is associated with a zone of a system and the summary groups the identified cyber-security risks by associated zones.

5. The method of claim 1, wherein the each cyber-security risk is classified by type selected from a notification, a warning, or an alert.

6. The method of claim 1, wherein the each cyber-security risk is classified by a type indicating a respective severity of the cyber-security risk.

7. The method of claim 1, wherein the summary includes an overall net site risk that indicates the relative overall cyber-security risk of the system.

8. A risk manager system comprising:
a controller; and
a display, the risk manager system configured to
identify a plurality of connected devices that are vulnerable to cyber-security risks;
identify cyber-security risks in the connected devices;
for each identified cyber-security risk, identify at least one possible cause, at least one recommended action, and at least one potential impact; and
display a user interface that includes a summary of the identified cyber-security risks.

9. The risk manager system of claim 8, wherein the summary includes graphical indicators including at least one of a trend-view chart, a 30-day graph, gauge graphics, colors, or symbols that designate risk types.

10. The risk manager system of claim 8, wherein the summary includes, for each identified cyber-security risk, the corresponding identified possible cause, recommended action, and potential impact.

11. The risk manager system of claim 8, wherein each of the connected devices is associated with a zone of a system and the summary groups the identified cyber-security risks by associated zones.

12. The risk manager system of claim 8, wherein the each cyber-security risk is classified by type selected from a notification, a warning, or an alert.

13. The risk manager system of claim 8, wherein the each cyber-security risk is classified by a type indicating a respective severity of the cyber-security risk.

14. The risk manager system of claim 8, wherein the summary includes an overall net site risk that indicates the relative overall cyber-security risk of the system.

15. A non-transitory machine-readable medium encoded with executable instructions that, when executed, cause one or more processors of a risk management system to:
identify a plurality of connected devices that are vulnerable to cyber-security risks;
identify cyber-security risks in the connected devices;
for each identified cyber-security risk, identify at least one possible cause, at least one recommended action, and at least one potential impact; and
display a user interface that includes a summary of the identified cyber-security risks.

16. The non-transitory machine-readable medium of claim 15, wherein the summary includes graphical indicators including at least one of a trend-view chart, a 30-day graph, gauge graphics, colors, or symbols that designate risk types.

17. The non-transitory machine-readable medium of claim 15, wherein the summary includes, for each identified cyber-security risk, the corresponding identified possible cause, recommended action, and potential impact.

18. The non-transitory machine-readable medium of claim 15, wherein each of the connected devices is associated with a zone of a system and the summary groups the identified cyber-security risks by associated zones.

19. The non-transitory machine-readable medium of claim 15, wherein the each cyber-security risk is classified by type selected from a notification, a warning, or an alert.

20. The non-transitory machine-readable medium of claim 15, wherein the each cyber-security risk is classified by a type indicating a respective severity of the cyber-security risk.
